(19) United States
(12) Patent Application Publication
(10) Pub. No.: US 2018/0147528 A1
(43) Pub. Date: May 31, 2018

(54) SYSTEM FOR SULFUR CONTAMINATE REMOVAL FROM HYDROCARBON LIQUIDS AND GASES AND METHODS THEREOF

(71) Applicant: Jeffrey St. Amant, La Porte, TX (US)

(72) Inventor: Jeffrey St. Amant, La Porte, TX (US)

(21) Appl. No.: 15/825,014

(22) Filed: Nov. 28, 2017

Related U.S. Application Data
(60) Provisional application No. 62/426,796, filed on Nov. 28, 2016.

(51) Int. Cl. B01D 53/86; B01J 20/22

(52) U.S. Cl. CPC B01D 53/8603; B01J 20/223; B01D 2257/306; C10G 2400/04; C10G 2300/202; C10G 2300/207; C10G 2400/02; B01D 2257/304

(57) ABSTRACT

A system and method for sulfur contaminate removal from hydrocarbon liquids and gases.

### CROSS-REFERENCE TO RELATED APPLICATION

This application claims the benefit of U.S. Provisional Patent Application Ser. No. 62/426,796, filed Nov. 28, 2016, the contents of which is incorporated by reference in its entirety.

### BACKGROUND

### 1. Field

The following description relates to a system and methods for sulfur contaminate removal from hydrocarbon liquids and gases.

### 2. Description of Related Art

A number of conventional processes are able to remove a small portion of sulfur compounds from hydrocarbons. Such conventional processes include caustic treaters such as Merox units, amine/aldehyde treaters, and some solid media that can react with the sulfur compounds, which are mostly fixed facilities within operating units that utilize expensive exotic catalyst and are very high in capital cost to design, install and operate. These traditional processes generally have some success in treating hydrogen sulfide, using chemistries such as caustic and specialty scavengers, e.g., SX-9281 and SX-9288, or impregnated and specialty carbons such as Sulfa Treat. However, other sulfide compounds such as mercaptans, carbon disulfide, dimethyl sulfide, diethyl sulfide, methyl ethyl sulfide, and dimethyl disulfide are more difficult to remove. Indeed, conventional processes have shown limited success in removing these sulfide compounds and are poorly-suited to reduce a content of sulfur-containing compounds below levels required by regulatory agencies.

Accordingly, there is a need for a mobile and modular system and method for sulfur removal from hydrocarbon liquids and/or gases that remedies the aforementioned deficiencies of conventional processes, and has the capability of removing specific sulfur compounds or removing a broad range of sulfur compounds.

### SUMMARY

The present inventive concept provides a system and method for sulfur removal from hydrocarbon liquids and gases that overcomes the aforementioned disadvantages of conventional processes. The system of the present inventive concept utilizes a number of components and related processes including but not limited to caustic wash, absorbents, liquid-liquid extraction, gas-liquid extraction, reactive chemistries, oxidative chemistries, and the like, in combination with contactor and/or reactor technology. It is foreseen that various additional methods and systems of the present inventive concept, e.g., utilizing existing technologies and/or new technologies and chemistry developments, will be apparent to one of ordinary skill in the art having the benefit of the present disclosure.

It is an objective of the present inventive concept to provide a system and method to treat sulfur compounds in light hydrocarbons such as, but not limited to, natural gas, propane, butane, LPG, NGL, naptha, Diesel, kerosene (e.g., jet fuel), gasoline, and/or other similar hydrocarbons.

It is an objective of the present inventive concept to provide a system and method to treat sulfide contaminates such as, but not limited to, hydrogen sulfide (HS), carbonyl sulfide (COS), carbon disulfide (CS₂), dimethyl sulfide (DMS), diethyl sulfide (DES), methyl ethyl sulfide, and mercaptans which are difficult to completely remove with H₂S scavengers, caustic treatments, and amine treatments.

It is an objective of the present inventive concept to provide a system and method that utilizes the contactor/reactor technology, among other things, to treat alkyl sulfides (R—S—R) and alkyl disulfides (R—S—S—R), which are not effectively managed by scavengers or other conventional treatments, thereby allowing users of the present inventive concept to at least meet and/or exceed new regulatory and/or commercial standards that dictate amount of sulfur content in fuels.

It is an objective of the present inventive concept to provide a system and method that utilizes the contactor/reactor technology, among other things, to treat higher mercaptans, e.g., R—S—H where R>C₃, which are only minimally removed by caustic treatments and are not very reactive toward common H₂S scavengers.

It is an objective of the present inventive concept to provide a system and method for treating difficult-to-remove sulfur compounds via an additive technology that includes, but is not limited to, a system having a plurality of components operable to treat such and related methods of using the system and the plurality of components.

It is an objective of the present inventive concept to provide a system and method for sulfur removal from hydrocarbon liquids and gases, e.g., including but not limited to light hydrocarbons.

It is an objective of the present inventive concept to provide a system and method for sulfur removal from hydrocarbon liquids and gases, which utilize chemistry that is compatible with water.

It is an objective of the present inventive concept to provide a system and method for sulfur removal from hydrocarbon liquids and gases that does not negatively impact treated hydrocarbons or refinery/terminal processes.

It is an objective of the present inventive concept to provide a system and method for sulfur removal from hydrocarbon liquids and gases that includes equipment that is mobile, modular, and operable to be economically and rapidly deployed without major capital expenditure.

It is an objective of the present inventive concept to provide a system and method for sulfur removal from hydrocarbon liquids and gases that includes equipment that is specifically designed, engineered, fabricated, and erected for specific application considerations.

It is an objective of the present inventive concept to provide a system and method for processing sulfur-contaminated fluid, i.e., gas and/or liquid, by forcing such through a liquid barrier (e.g., a sintered permeable membrane), which is operable to force contact between one or more sulfur compounds and one or more chemicals.

It is an objective of the present inventive concept to provide a system and method with one or more contactor scrubbers and one or more chemicals to provide homogenous-like or homogenous mixing, thereby providing intense interaction between the one or more sulfur compounds and the one or more chemicals.

It is an objective of the present inventive concept to provide a system and method for processing sulfur contaminated fluid that has significantly-improved performance with respect to sulfur removal relative to conventional systems and methods.

It is an objective of the present inventive concept to provide a system and method for processing sulfur-contaminated fluids that yield superior contaminate removal and chemical utilization relative to conventional systems and methods for treating sulfur contaminated fluid.

The foregoing is intended to be illustrative and is not meant in a limiting sense. Many features of the embodiments may be employed with or without reference to other features of any of the embodiments. Additional aspects, advantages, and/or utilities of the present inventive concept will be set forth in part in the description that follows and, in part, will be apparent from the description, or may be learned by practice of the present inventive concept.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the present disclosure. It should be understood, however, that the present inventive concept is not limited to the precise embodiments and features shown. The accompanying drawings, which are incorporated in and constitute a part of this specification, illustrate an implementation of apparatuses consistent with the present inventive concept and, together with the description, serve to explain advantages and principles consistent with the present inventive concept.

FIG. 1 is a schematic diagram of a vessel for reducing a concentration of sulfur-containing compounds in a contaminated hydrocarbon fluid, according to an illustrative embodiment.

FIG. 2 is a flow diagram is presented of a process for removing sulfur-containing compounds from a hydrocarbon fluid, according to an illustrative embodiment.

FIG. 3 is a flow diagram of a process for removing sulfur-containing compounds from a liquid portion of a hydrocarbon fluid, according to an illustrative embodiment.

FIG. 4 is a flow diagram of a process for removing sulfur-containing compounds from a gas portion of a hydrocarbon fluid, according to an illustrative embodiment.

FIG. 5 is a schematic diagram of a system for treating a hydrocarbon fluid to reduce a concentration of sulfur compounds in a naptha-containing portion of the hydrocarbon fluid, according to an illustrative embodiment.

FIG. 6 is a schematic diagram of a system for reducing a concentration of sulfur compounds using a plurality of reactors, according to an illustrative embodiment.

FIG. 7 is a schematic diagram of a system for reducing a concentration of sulfur compounds in a hydrocarbon fluid, according to an illustrative embodiment.

FIG. 8 is a diagram illustrating performance test results via the system and method of the present inventive concept.

FIG. 9 is a schematic diagram of a system for reducing a concentration of sulfur compounds in a hydrocarbon fluid, according to an illustrative embodiment.

FIG. 10 a schematic diagram is presented of the system having a first stage treatment contactor in a stacked configuration with a second-stage treatment contactor, according to an illustrative embodiment.

FIG. 11 is a diagram illustrating the system and method of the present inventive concept, i.e., a Vapor Lock unit operable to contact and scrub contaminates from a petroleum liquid, the system including a regenerable chemical operable to capture sulfur compounds, the regeneration capable of mobile transport and operable to be performed on location.

### DETAILED DESCRIPTION

It is to be understood that the present inventive concept is not limited in its application to the details of construction and to the embodiments of the components set forth in the following description or illustrated in the drawings. The figures and written description are provided to teach any person skilled in the art to make and use the inventions for which patent protection is sought. The present inventive concept is capable of other embodiments and of being practiced and carried out in various ways. Persons of skill in the art will appreciate that the development of an actual commercial embodiment incorporating aspects of the present inventive concept will require numerous implementations—specific decisions to achieve the developer's ultimate goal for the commercial embodiment. While these efforts may be complex and time-consuming, these efforts, nevertheless, would be a routine undertaking for those of skill in the art of having the benefit of this disclosure.

### I. Terminology

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the present inventive concept or the appended claims. Further, it should be understood that any one of the features of the present inventive concept may be used separately or in combination with other features. Other systems, methods, features, and advantages of the present inventive concept will be, or become, apparent to one with skill in the art upon examination of the figures and the detailed description. It is intended that all such additional systems, methods, features, and advantages be included within this description, be within the scope of the present inventive concept, and be protected by the accompanying claims.

Further, any term of degree such as, but not limited to, “substantially,” as used in the description and the appended claims, should be understood to include an exact, or a similar, but not exact configuration. For example, “a substantially planar surface” means having an exact planar surface or a similar, but not exact planar surface. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Further, as the present inventive concept is susceptible to embodiments of many different forms, it is intended that the present disclosure be considered as an example of the principles of the present inventive concept and not intended to limit the present inventive concept to the specific embodiments shown and described. Any one of the features of the present inventive concept may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments, but is not necessarily included. Thus, the present inventive concept may include a variety of combinations and/or integrations of the embodiments described herein. Additionally, all aspects of the present disclosure, as described herein, are not essential for its practice. Likewise, other systems, methods, features, and advantages of the present inventive concept will be, or become, apparent to one with skill in the art upon examination of the figures and the description. It is intended that all such additional systems, methods, features, and advantages be included within this description, be within the scope of the present inventive concept, and be encompassed by the claims.

Lastly, the terms “or” and “and/or,” as used herein, are to be interpreted as inclusive or meaning any one or any combination. Therefore, “A, B or C” or “A, B and/or C” mean any of the following: “A,” “B,” “C”; “A and B”; “A and C”; “B and C”; “A, B and C.” An exception to this definition will occur only when a combination of elements, functions, steps or acts are in some way inherently mutually exclusive.

As used herein, the term “hydrocarbon fluid” may refer to a gas, a liquid, or a combination thereof.

### II. General Architecture

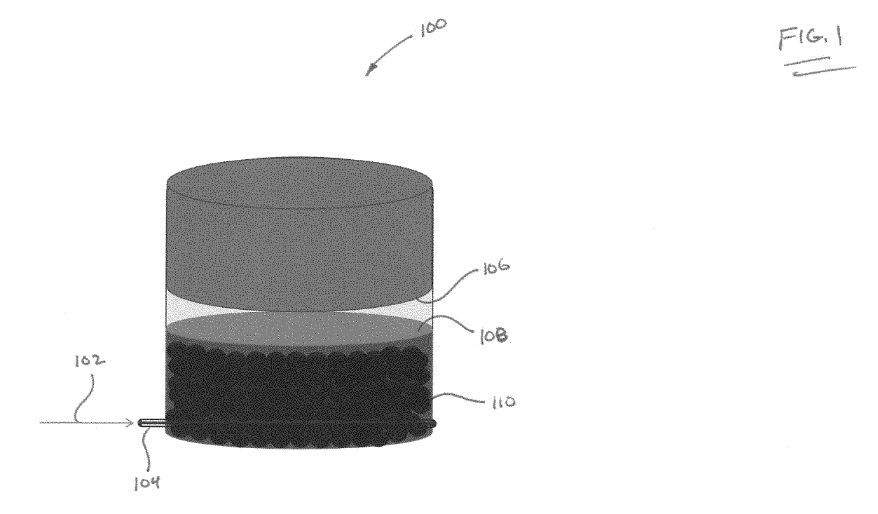

Turning to FIGS. 1-11, various aspects of the system and method of the present inventive concept are illustrated. The system of the inventive concept provides a mobile and scalable modular design that allows for the treatment of sulfur compounds from hydrocarbon streams in a compact, mobile fashion. Moreover, the system and method provide an alternative to the significant capital and operational costs associated with permenant/fixed exotic catalyst based systems.

In FIG. 1, a schematic diagram is presented of a vessel 100 for reducing a concentration of sulfur-containing compounds in a contaminated hydrocarbon fluid 102, according to an illustrative embodiment. The vessel 100 includes an inlet 104 for receiving the contaminated hydrocarbon fluid 102 and an outlet (not shown) for discharging a purified (or scrubbed) hydrocarbon fluid 106. The purified hydrocarbon fluid 106 has a reduced concentration of sulfur compounds relative to the contaminated hydrocarbon fluid 102. Disposed within the vessel 100 is a liquid media 108 capable of reacting with one or more sulfur compounds within the contaminated hydrocarbon fluid 102. Non-limiting examples of the liquid media 108 include the PETROSWEET™ family of products supplied by Baker Hughes (e.g., HSO3507, HSW7334, HSW7336, etc.).

The vessel 100 also includes a mechanical contactor 110 disposed therein. The mechanical contactor 110 is operable to force contact between the contaminated hydrocarbon fluid 102 and the liquid media 108. In some embodiments, the mechanical contactor 110 serves as a barrier to the liquid media 108. In these embodiments, the contaminated hydrocarbon fluid 102 is forced through the barrier to contact the liquid media 108. For example, and without limitation, the mechanical contactor 110 may be a sintered permeable membrane in contact with the liquid media 108. During operation, the mechanical contactor 110 receives the contaminated hydrocarbon fluid 102, and via channels and/or pores therein, intimately disperses the contaminated hydrocarbon fluid 102 into the liquid media 108. In this manner, the mechanical contactor 110 provides homogenous-like mixing, thereby creating intense interaction between the contaminated hydrocarbon fluid 102 and the liquid media 108. The mechanical contactor 110 may also create an environment for separation through diffusion. The liquid media 106 may be selected in chemistry to allow rapid reaction with one or more sulfur compounds in the contaminated hydrocarbon fluid 102. Thus, the intimate contact allowed by the mechanical contactor 110 yields superior product usage, improves a reaction or contact interface as compared to conventional processes, and produces sulfur removal results not currently achievable through conventional technologies.

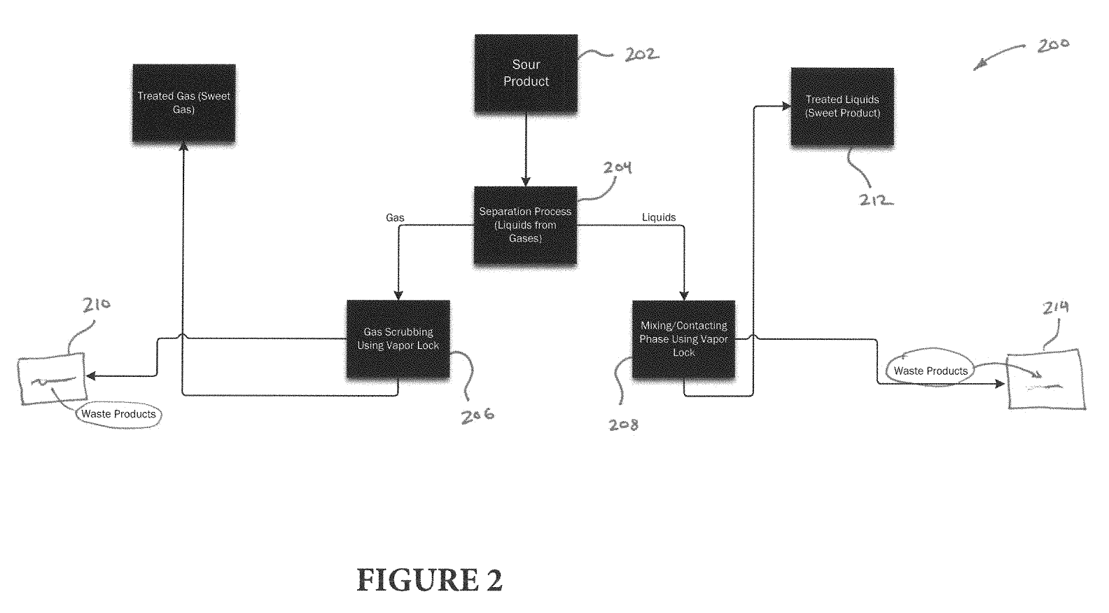

Referring now to FIG. 2, a flow diagram is presented of a process 200 for removing sulfur-containing compounds from a hydrocarbon fluid, according to an illustrative embodiment. The hydrocarbon fluid may be supplied from a source, represented by block 202, and includes one or more sulfur-containing compounds. In this state, the hydrocarbon fluid may be a “sour product” or a “sour crude”. The hydrocarbon fluid is separated into a gas component and a liquid component, as shown by block 204. Such separation may involve any type of process capable of separating a gas phase from a liquid phase, such as gravity draining, centrifugal action, sparging via carrier gas, reduced pressure take-off, change in temperature, and so forth.

The gas component of the hydrocarbon liquid is scrubbed to reduce a concentration of sulfur-containing compounds therein, thereby producing a treated gas component (or “sweet gas”). Scrubbing of the gas component may occur in a vessel analogous to the vessel 100 described in relation to FIG. 1. Scrubbing of the gas component is shown by block 206, which in some embodiments, may also involve the production of waste products. The treated gas component—shown by block 208—may be stored, or alternatively, sent for subsequent processing or consumption. The waste products may be stored or sent for subsequent processing (see block 210). Similarly, the liquid component of the hydrocarbon fluid is scrubbed to reduce a concentration of sulfur-containing compounds therein, thereby producing a treaded liquid component (or “sweet product”). Scrubbing of the liquid component may occur in a vessel analogous to vessel 100 described in relation to vessel 100 of FIG. 1. Scrubbing of the liquid component is shown by block 212, which may also involve the production of waste products. The waste products may be stored or sent for subsequent processing (see block 214).

With respect to gas versus liquid treatments, it has been discovered that gas treatments provide little variability to approaches in view of operational parameters/variables. Separation occurs instantaneously with little additional separation or filtration required. Conversely, liquid treatments can have significant variability depending on operational parameters/variables. Additional upfront filtration and/or separation can be required to ensure that product is reasonably free of solids, and that condensable fluids will be separated (at operating conditions) prior to chemical treatment. It is also anticipated that additional separation may be required to allow for additional residence time in the separator than the gas treatment, along with the potential need for post treatment filtration potentially, e.g., water washing and/or clay/particulate filtration.

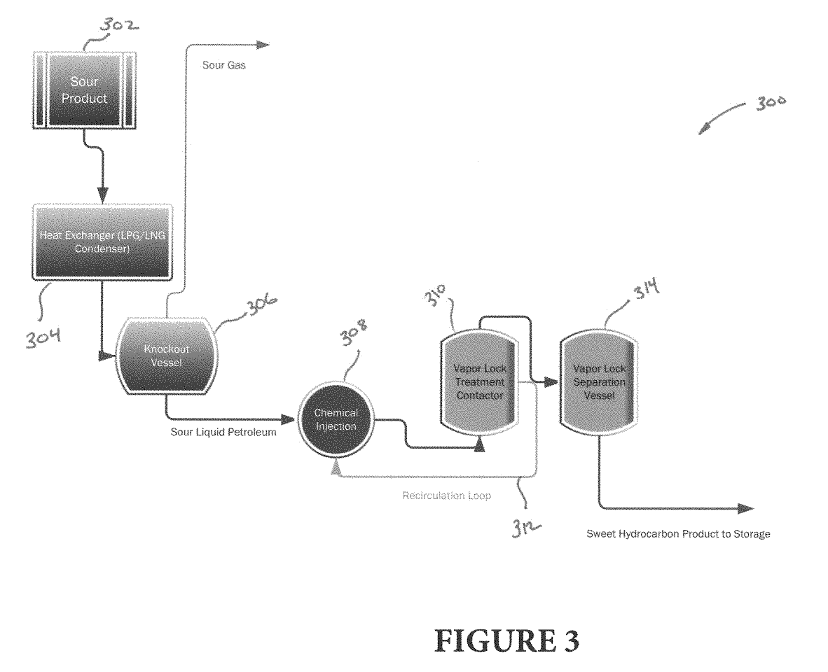

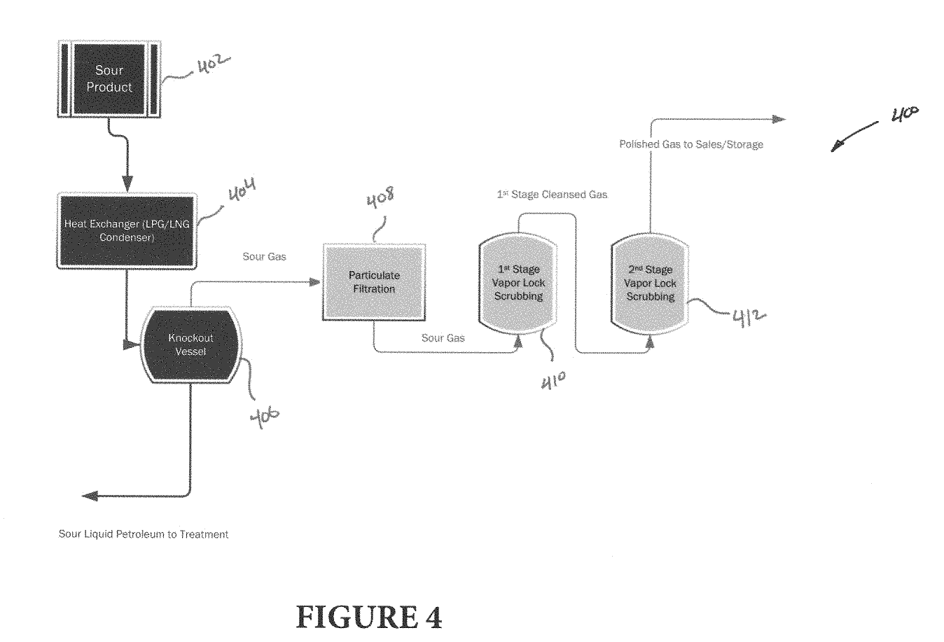

Turning now to FIGS. 3-4, these figures present flow diagrams of treatment systems for combined gas/liquid phase streams. The diagrams depict the basic phases of treatment for mixed streams, as well as individual gas-only (or vapor-only) streams. It should be noted that with any of these systems, depending upon the commercial terms required, the systems could represent initial stages of treatment. For example, and without limitation, if easily removed contaminates are present (e.g. hydrogen sulfide), such contaminants may be removed in a separate contactor or scrubbing unit, prior to introduction into the aforementioned systems. Such pre-treatment may prevent contamination, reaction, or rapid saturation of specialty chemistries used for the treatment of the more difficult to remove sulfur compounds. Alternatively, such treatment could be part of an intermediate- or post-treatment process (e.g., after a separation process) to ensure that the resulting product is within contractual commercial terms.

FIG. 3 presents a flow diagram of a process 300 for removing sulfur-containing compounds from a liquid portion of a hydrocarbon fluid, according to an illustrative embodiment. In the process 300, a source 302 supplies the hydrocarbon fluid (or “sour product”) to a heat exchanger 304, which may be a condenser configured to condense liquid petroleum gas (LPG), liquid natural gas (LNG), or both. A knock-out vessel 306 separates the hydrocarbon fluid into a gas portion (i.e., “sour gas”) and the liquid portion (i.e., “sour liquid petroleum”). The liquid portion is processed in a chemical injector 308, which injects a chemical into the liquid portion. The liquid portion (with the chemical) is then transferred to a treatment contactor 310. The treatment contactor 310 may be analogous to the vessel 100 described in relation to FIG. 1. The treatment contactor 310 aids the chemical in removing sulfur compounds from the liquid portion, which exits the treatment contactor 310 to enter a separation vessel 312. The chemical returns to the chemical injector 308 via a recirculation loop 314. The separation vessel 314 removes undesired components from the liquid portion to produce a sweet hydrocarbon product. The separation vessel 314 may be a polishing scrubber to remove residual sulfur-containing or other compounds (e.g., hydrofluoric acid). In some embodiments, the sweet hydrocarbon product is transferred into storage.

FIG. 4 presents a flow diagram of a process 400 for removing sulfur-containing compounds from a gas portion of a hydrocarbon fluid, according to an illustrative embodiment. In the process 400, a source 402 supplies the hydrocarbon fluid (or “sour product”) to a heat exchanger 404, which may be a condenser configured to condense liquid petroleum gas (LPG), liquid natural gas (LNG), or both. A knock-out vessel 406 separates the hydrocarbon fluid into a liquid portion (i.e., “sour liquid petroleum”) and the gas portion (i.e., “sour gas”). The gas portion then traverses a particulate filtration unit 408 to remove contaminate particles therein. Other types of contaminants may also be removed (e.g., liquid droplets). The gas portion then enters a primary scrubbing unit 410, which may be analogous to the vessel 100 described in relation to FIG. 1. The primary scrubbing unit 410 produces a first-stage cleansed gas, which enters a secondary scrubbing unit 412. The secondary scrubbing unit 412 is operable to produce a polished gas, which may be transferred for sale or storage for subsequent use. In some embodiments, the secondary scrubbing unit 412 is analogous to the vessel 100 described in relation to FIG. 1. In other embodiments, the secondary scrubbing unit 412 is configured differently than the vessel 100. For example, and without limitation, the secondary scrubbing unit 412 may configured to remove acidic gases in the first-stage cleansed gas (e.g., hydrofluoric acid).

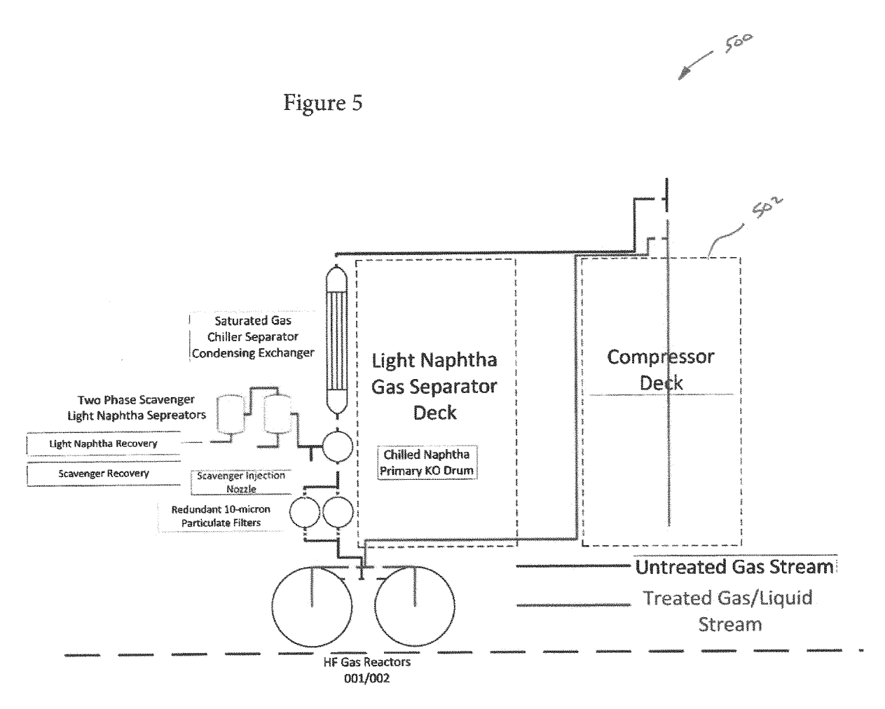

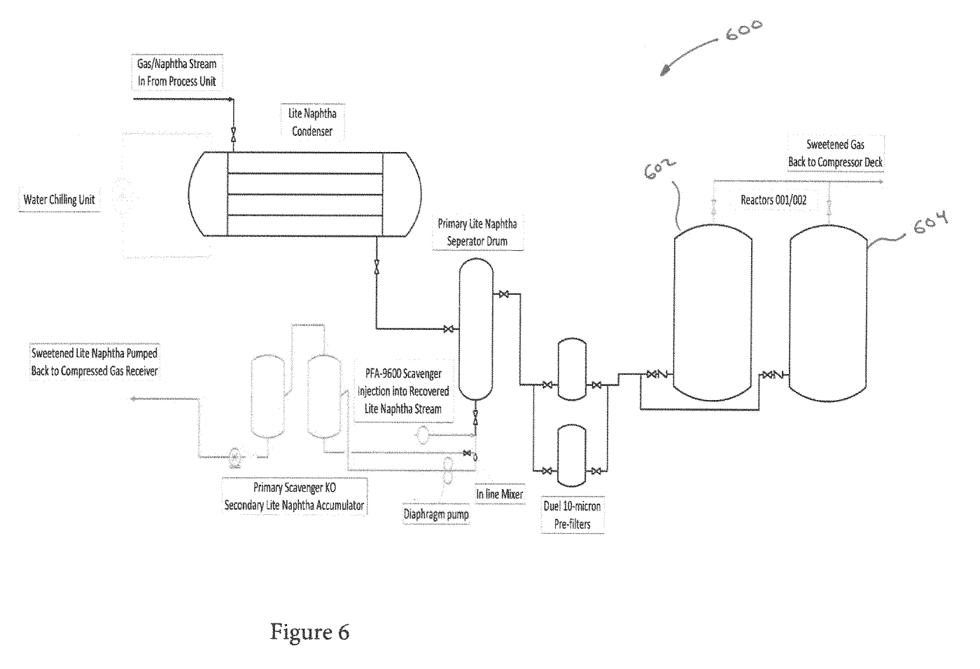

Turning now to FIG. 5, a schematic diagram is presented of a system 500 for treating a hydrocarbon fluid to reduce a concentration of sulfur compounds in a naptha-containing portion of the hydrocarbon fluid, according to an illustrative embodiment. The system 500 may also reduce a concentration of sulfur compounds in other portions of the hydrocarbon fluid. The system 500 includes a compressor deck 502 configured to receive a treated hydrocarbon gas stream. FIG. 6 presents a schematic diagram of a system 600 for reducing a concentration of sulfur compounds using reactors 602, 604 analogous to the vessel 100 described in relation to FIG. 1. The reactors 602, 604 are fluidly-connected to the compressor deck 502 of FIG. 5 and are operable to supply the treated hydrocarbon gas stream thereto.

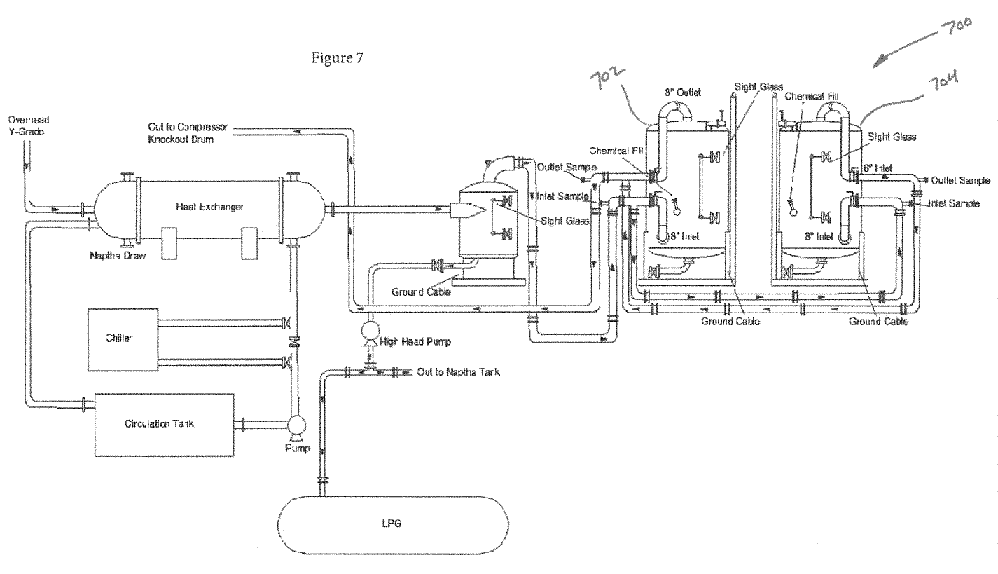

Referring now to FIG. 7, a schematic diagram is presented of a system 700 for reducing a concentration of sulfur compounds in a hydrocarbon fluid, according to an illustrative embodiment. The system 700 includes a first treatment contactor 702 (or first reactor) and a second treatment contactor 704 (or second reactor). The first treatment contactor 702 and the second treatment contactor may be analogous to the vessel 100 described in relation to FIG. 1.

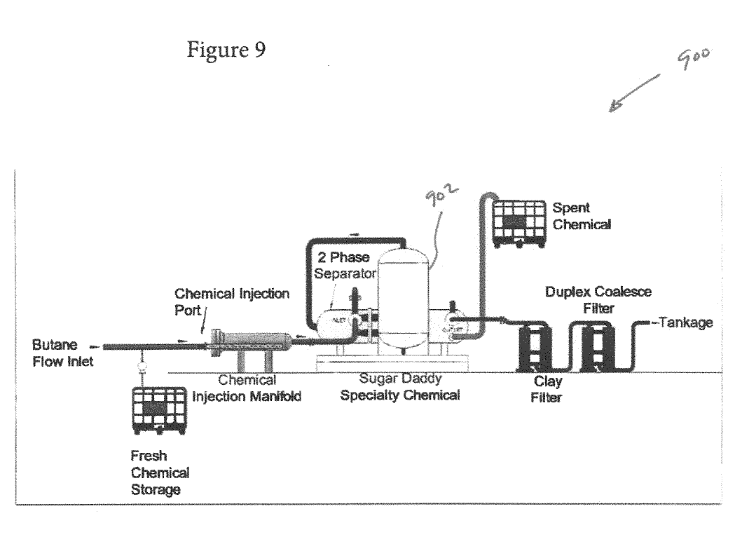

Turning now to FIG. 9, a schematic diagram is presented of a system 900 for reducing a concentration of sulfur compounds in a hydrocarbon fluid, according to an illustrative embodiment. FIG. 9 depicts the hydrocarbon fluid as butane, however, this depiction is not intended as limiting. The system 900 includes a vessel 902 operable to remove sulfur compounds from a stream of butane. The vessel 902 is analogous to the vessel 100 described in relation to FIG. 1. It will be appreciated that the vessel 902 includes a combination of a selected chemical and a mechanical contactor to provide homogenous-like mixing, thereby creating an intense interaction between the selected chemical and the stream of butane. This intimate contact yields superior product usage and an improved reaction/contact interface as compared to conventional processes.

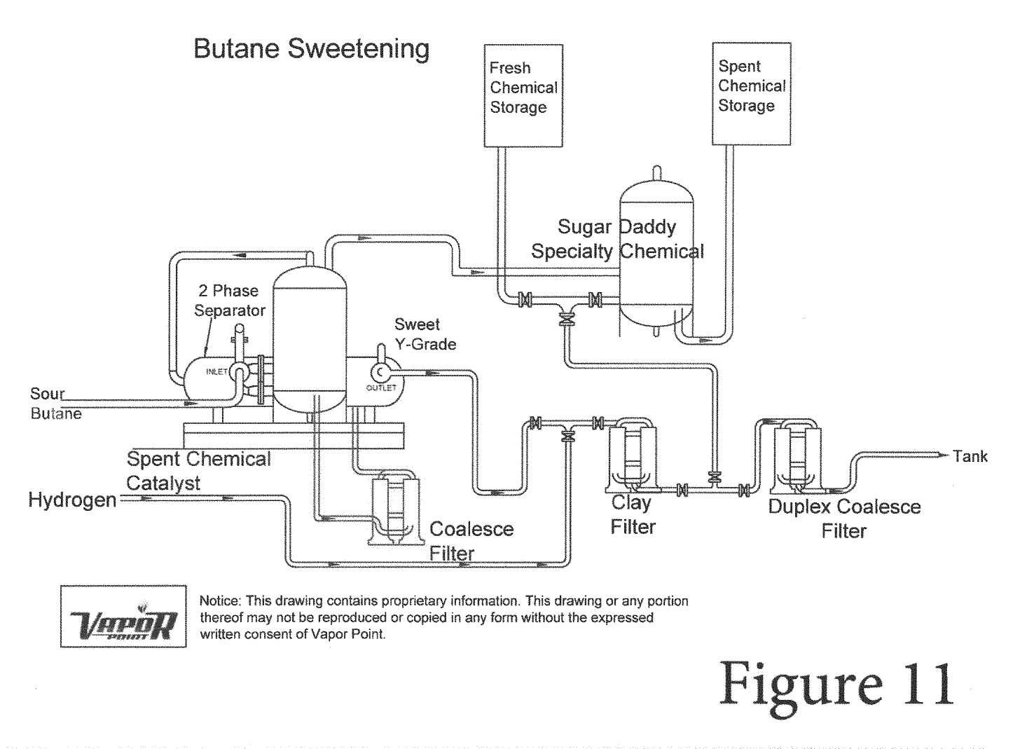

Additionally, as depicted in FIG. 11 the process/system can have multiple iterations for achievement of commercial terms. In FIG. 11, based on these specialty chemistries used, a regeneration step can be incorporated, using heated hydrogen, nitrogen or other gas (potentially including air), such that specialty chemistry/catalyst is stripped of captured, reacted, and/or absorbed contaminate. In this step, another treatment can be deployed to capture the stripped components. Other regeneration methods could be utilized, as determined by the specific chemistries/catalyst/absorbents utilized.

It should be noted, that different chemistries, catalyst, or other media can be used, individually or in combination, as a part of this treatment approach as a either a pre-treatment stage, post-treatment stage. New specialty materials known as metal organic frameworks (MOFs), such as PCN-250 as developed by Texas A&M University and framergy Inc., can be used in this system and method as descried above. The MOFs can be used for bulk or selective treatment of contaminates, through absorption of said contaminates, and the regeneration step, as shown in FIG. 11, can be inclusive of such methods. However, the regeneration property and resulting stripped fluid could vary.

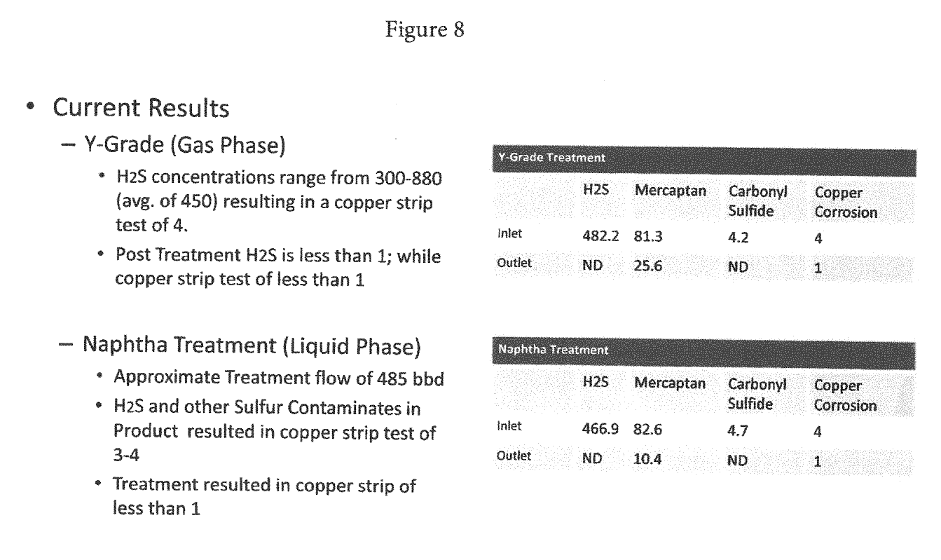

Turning now to FIG. 8, field trial results of the system and method of the present inventive concept are provided. Application parameters included a flow of 200-250 bbl/hr. Contaminates operable for processing via the system and method of the present inventive concept include carbon disulfide, dimethyl sulfide, diethyl sulfide, methyl ethyl sulfide, benzothiophene, DMDS, and/or carbonyl sulfide. Sulfur reduction ranges from 72 ppm to less than 5 ppm. Pressure is 75 psi. Initial temperature is greater than 200° F., and is cooled to below 140° F. It should be noted that through conventional laboratory testing methods, only an 15% approximate reduction sulfur was realized, whereas field testing utilizing the systems and methods described herein resulted in greater than 98% reduction (see FIG. 8).

The scalable nature of the system and method of the present inventive concept are capable of operating at flow rates over 10,000 bbl/hr, although typical production is about 250-1000 bbl/hr. A reduction target for total sulfur content may be selected to allow for the blending of fuels at less than 10 ppm total sulfur, in accordance with EPA Tier III fuel standards (or other commercial standards for non-vehicle fuels). The system design will be directly dependent on total sulfur and total production capacity (in bbl/day or scf/day or other similar measure) in the untreated fuel. It should be noted that the standards referenced may be different based on individual client requirements for specific commercial terms and/or regulatory standards.

It will be appreciated by those skilled in the art that changes could be made to the embodiments described above without departing from the broad inventive concept thereof. It is understood, therefore, that the present inventive concept disclosed herein is not limited to the particular embodiments disclosed, and is intended to cover modifications within the spirit and scope of the present inventive concept.

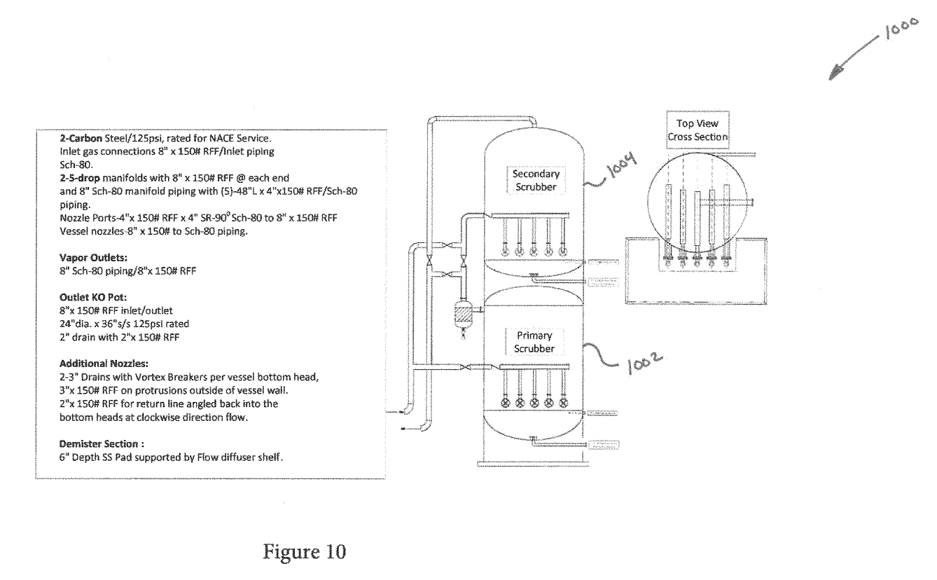

Turning now to FIG. 10, a schematic diagram is presented of the system 1000 having a first stage treatment contactor 1002 in a stacked configuration with a second-stage treatment contactor 1004, according to an illustrative embodiment. The first stage treatment contactor 1002 and the second stage treatment contactor 1004 are analogous to the vessel 100 described in relation to FIG. 1. The stack configuration allows the first- and second-stage treatment contactors 1002, 1004 to operate sequentially or in parallel.

It should be noted that, within each identified “scrubber” or treatment contactor, there would be a maintained liquid level of selective chemistries, at least covering the internal mixing/diffusion system, with untreated fuel being introduced into the treatment contactor through the mixing/diffusion system, for cylindrical type mixing/diffusion membrane, or from underneath the mixing/diffusion system for mixing/diffusion systems that utilize sheet or plate internal mixer/diffuser, where the fuel is treated after having passed through the internal mixing/diffusion system having contacted the specialty/targeted chemistries and then phase separating based on the specific gravity of the two different fluids, and finally being directed from an outlet of the scrubber unit(s) with the potential (particularly for liquid phases) to be initially directed into a final knockout pot or inlet of an additional scrubber unit, which isn't filled with liquid, to act as a final separation phase should any specialty/target chemistries flow through. In this final separation phase, the fuel would be further separated using specific gravity principles, whereby the treated liquid is removed through an outlet, while the specialty/target chemistry is removed from a separate outlet.

It should be noted, that each treatment contactor can, but may not have similar chemistries, absorbers or other media types. Non-limiting examples of the types of media that could be contained within the treatment contactor include commodity chemistries such as caustic, specialty scavengers such as Baker Hughes Exalt 1000 or 1100, solids medias such as activated carbon or ion exchange resins, or even different designed metal organic frameworks or similar non-metal structures.

It should further be noted, that the initial treatment contactor (primary), can have a selective chemistry used for converting hard to capture sulfur contaminates into easily reactive sulfur compounds, such as hydrogen sulfide (H₂S), which then the secondary contactor can have commodity chemistries such as caustic, specialty scavengers, solids medias or even MOFs for the capture of H₂S.

The illustrative systems and methods may also be described by the following non-limiting examples.

### Example 1

A system for sulfur contaminate removal from hydrocarbon liquids and gases, the system comprising:

a pipeline having a hydrocarbon flow inlet operable to transport untreated or partially/incompletely treated hydrocarbon;

a treatment contactor in communication with the pipeline, the treatment contactor having a minimum level of chemistry sufficient to cover the internal membrane configuration such that the untreated or partially/incompletely treated hydrocarbon fluid is in initial communication with the chemistry as the untreated or partially/incompletely treated hydrocarbon enters the treatment contactor, the treatment contactor comprising:
(i) a first inlet from the untreated or incompletely treated hydrocarbon pipeline,
(ii) an internal membrane configured to provide mixing/contacting and/or diffusion of untreated or incompletely treated hydrocarbon and chemistry,
(iii) a separation zone to allow for the phase separation of the treated hydrocarbon,
(iv) an initial outlet to allow for the exiting of the treated or partially treated hydrocarbon outlet to a second chemical storage unit, and
(vi) a second outlet to allow for the exiting of the used or partially used chemistry.

### Example 2

The system of example 1, wherein the membrane is permeable.

### Example 3

The system of example 1, wherein the membrane is sintered.

### Example 4

The system of example 1, wherein the untreated or partially/incompletely treated hydrocarbon fluid is one or more gases and/or liquids, at ambient conditions, that includes undesirable sulfur.

### Example 5

The system of example 1, wherein the contactor is operable to force contact between one of more sulfur compounds and one or more chemistries.

### Example 6

The system of example 1, wherein the contactor is able to provide homogenous-like mixing.

### Example 7

The system of example 1, wherein the contactor is operable to cause or facilitate an intense interaction between one or more sulfur compounds and one or more chemistries.

### Example 8

The system of example 1, wherein the membrane increases the interaction between one of more sulfur compounds and one or more chemistries within the membrane.

### Example 9

The system of example 1, wherein the membrane diffuses the hydrocarbon fluid and one or more chemistries as the homogenous-like fluid exits the membrane surface.

### Example 10

The system of example 1, wherein, in the zone above the membrane, separation of the hydrocarbon fluid and one or more chemistries occurs.

### Example 11

The system of example 1, wherein a liquid interface develops between the hydrocarbon fluid and one or more chemistries.

### Example 12

The system of example 1, wherein the treated hydrocarbon fluid contains a lower sulfur concentration than the untreated or partially/incompletely treated hydrocarbon fluid.

### Example 13

The system of example 1, wherein the system includes a chemical injection manifold in communication with the pipeline via a chemical injection port.

### Example 14

The system of example 13, further comprising a similar membrane, as contained in example 1, to provide for initial chemistry and untreated hydrocarbon mixing/contact interface.

### Example 15

The system of example 13, further comprising a separate inlet to allow for the injection of chemistry prior to communication with the membrane of the system in example 2.

### Example 16

The system of example 1, further comprising of a separator vessel prior to the inlet of the treatment contactor.

### Example 17

The system of example 16, further comprising a heat exchanger prior to the inlet of the separator vessel.

### Example 18

The system of example 17, further comprising a cooling fluid.

### Example 19

The system of example 1, further comprising of a filter vessel prior to the inlet of the treatment contactor.

### Example 20

The system of example 1, further comprising a filter vessel after the initial outlet of the treatment contactor where the treated hydrocarbon fluid undergoes additional conditioning.

### Example 21

The system of example 1, wherein the initial outlet is in communication with a pipeline capable of transporting the treated hydrocarbon fluid

### Example 22

The system of example 1, wherein the secondary outlet is in communication with a pipeline capable of transporting the used or partially used chemistry to a storage container

### Example 23

The system of example 1, wherein an additional inlet may be disposed to allow for the injection of unused or partially used chemistries into the contactor device.

### Example 24

A method for sulfur contaminate removal from hydrocarbon liquids and gases, the method comprising steps of:

transporting untreated or partially/incompletely treated hydrocarbon (“untreated hydrocarbon fluid”) fluid via pipeline from storage, process unit, transport vessel, or other pipeline infrastructure;

securing the untreated hydrocarbon fluid pipeline such that it is in communication with the treatment contactor system;

securing the treatment contactor system to transport pipeline for treated hydrocarbon fluid;

filling the treatment contactor, which includes a sintered permeable membrane, with one or more chemistries in singularity or in combination to at minimum cover the sintered permeable membrane;

introducing the untreated hydrocarbon fluid from the source pipeline into the treatment contactor inlet piping;

wherein optionally the untreated hydrocarbon fluid begins to contact one or more chemistries as the untreated hydrocarbon enters the treatment contactor inlet piping;

wherein optionally, as the untreated hydrocarbon fluid begins to contact the chemistry, some of the sulfur compounds will be removed from the hydrocarbon fluid;

wherein optionally, as the combination of the untreated hydrocarbon fluid and the chemistry enters the sintered permeable membrane, the sintered permeable membrane causes increased interaction/contact due to the tortuous path of the membrane and the resulting back pressure of the membrane creating a homogenous-like mixture;

wherein optionally, as the combination of the untreated hydrocarbon fluid and the chemistry flows through the sintered permeable membrane, additional sulfur compounds are removed from the hydrocarbon fluid;

wherein optionally, as the combination of the untreated hydrocarbon fluid and the chemistry exits the membrane, the hydrocarbon fluid and chemistry mixture is diffused above the sintered permeable membrane; and

wherein optionally, as the diffused mixture separates above the sintered permeable membrane, an interface will be developed between the treated hydrocarbon fluid and the used or partially used chemistry to allow for the separate exiting of the treated hydrocarbon and the used or partially used chemistry.

### Example 25

The method of example 24, wherein the untreated or partially treated hydrocarbon fluid may initially be cooled to allow for the separation of liquid and gas phase hydrocarbons to allow for the separate untreated hydrocarbon treatment of the liquid and the gas.

### Example 26

The method of example 24, further comprising one or more filter vessels for the removal of solids that may be entrained in the hydrocarbon fluid.

### Example 27

The method of example 24, further comprising an injection contactor manifold system to allow for the injection of one or more chemistries into the untreated or partially/incomplete hydrocarbon product, and initial communication between untreated hydrocarbon and one or more chemistries for the initial removal of sulfur compounds.

### Example 28

The method of example 24, further comprising additional separator vessels deployed to be in communication with the contactor system after the initial separation occurs within the contactor system, thereby allowing for additional separation of the treated hydrocarbon and used or partially used chemistry.

### Example 29

The method of example 24, further comprising of one or more filter vessels to allow for the separation and removal of any suspended solids or reaction products.

### Example 30

The method of example 24, further comprising of one or more additional filter vessels to allow for further hydrocarbon product treatment to allow for non-sulfur product specification improvements.

### Example 31

The method of example 30, wherein the filter vessel(s) contain media such as activated or non-activated charcoal, clay, mole sieve, pecan shells, or other media for the purpose of meeting hydrocarbon product treatment specifications.

### Example 32

The method of example 24, wherein the treatment contactor contains a solid media such as a activated carbon, a metal organic framework, or similar solid materials/media chemistry for the purposes of removing sulfur contaminates.

### Example 33

The method of claim 32, comprises the following steps:

transporting untreated or partially/incompletely treated hydrocarbon (“untreated hydrocarbon fluid”) fluid via pipeline from storage, process unit, transport vessel, or other pipeline infrastructure;

securing the untreated hydrocarbon fluid pipeline such that it is in communication with the treatment contactor system;

securing the treatment contactor system to transport pipeline for treated hydrocarbon fluid;

filling the treatment contactor, which includes a sintered permeable membrane, with one or more solid materials/media singularity or in combination to at minimum cover the sintered permeable membrane;
introducing the untreated hydrocarbon fluid from the source pipeline into the treatment contactor inlet piping;

wherein optionally, as the untreated hydrocarbon fluid enters the sintered permeable membrane, the sintered permeable membrane diffuses the hydrocarbon fluid into the solid media;

wherein optionally the sintered permeable membrane diffuses the contaminated hydrocarbon fluid into the solid media such that the solid media engages with the contaminated hydrocarbon fluid allowing for the removal of some or all of the sulfur contaminates from the hydrocarbon fluid; and

wherein optionally, as the treated hydrocarbon fluid exits the treatment contactor, the treated hydrocarbon fluid is then engaged with the treated hydrocarbon pipeline.

### Example 34

The method of example 32 further comprises a recycling step to allow for the conversion or separation of the used or partially used chemistry(s), allowing for the reuse of the used or partially used chemistry(s).

### Example 35

The method of example 32 further comprises a recycling step to allow for the conversion or separation of the used or partially used solid media chemistry(s), allowing for the reuse of the used or partially used solid media chemistry(s).

What is claimed is:

1. A system for sulfur contaminate removal from hydrocarbon liquids and gases, the system comprising:
a pipeline having a hydrocarbon flow inlet operable to transport untreated or partially/incompletely treated hydrocarbon; and
a treatment contactor in communication with the pipeline, and having a minimum level of chemistry sufficient to cover an internal membrane configuration such that untreated or partially/incompletely treated hydrocarbon fluid is in initial communication with the chemistry as the untreated or partially/incompletely treated hydrocarbon enters the treatment contactor, the treatment contactor comprising:
(i) a first inlet from the untreated or incompletely treated hydrocarbon pipeline,
(ii) an internal membrane configured to provide mixing/contacting and/or diffusion of untreated or incompletely treated hydrocarbon and chemistry,
(iii) a separation zone to allow for phase separation of the treated hydrocarbon,
(iv) an initial outlet to allow for exiting of the untreated or partially treated hydrocarbon outlet to a second chemical storage unit, and
(vi) a second outlet to allow for exiting of used or partially used chemistry.

2. The system of claim 1, wherein the membrane is permeable.

3. The system of claim 1, wherein the membrane is sintered.

4. The system of claim 1, wherein the untreated or partially treated hydrocarbon fluid is one or more gases and/or liquids, at ambient conditions, that includes undesirable sulfur.

5. The system of claim 1, wherein the treatment contactor is operable to force contact between one of more sulfur compounds and one or more chemistries.

6. The system of claim 1, wherein the treatment contactor is able to provide homogenous-like mixing.

7. The system of claim 1, wherein the treatment contactor is operable to cause or facilitate an intense interaction between one or more sulfur compounds and one or more chemistries.

8. The system of claim 1, wherein the membrane is operable to increase interaction between one of more sulfur compounds and one or more chemistries within the membrane.

9. The system of claim 1, wherein the membrane is operable to diffuse the hydrocarbon fluid and one or more chemistries as homogenous-like fluid exits the membrane.

10. The system of claim 1, wherein, separation of the hydrocarbon fluid and one or more chemistries occurs in a zone above the membrane.

11. The system of claim 1, wherein the system is operable to cause a liquid interface to develop between the hydrocarbon fluid and one or more chemistries.

12. The system of claim 1, wherein the treated hydrocarbon fluid contains a lower sulfur concentration than the untreated or partially/incompletely treated hydrocarbon fluid.

13. The system of claim 1, wherein the system includes a chemical injection manifold in communication with the pipeline via a chemical injection port.

14. The system of claim 13, further comprising a similar membrane, as contained in example 1, to provide for initial chemistry and untreated hydrocarbon mixing/contact interface.

15. The system of claim 13, further comprising a separate inlet operable to allow for injection of chemistry prior to communication with the membrane of the system.

16. The system of claim 1, further comprising a separator vessel positioned prior to an inlet of the treatment contactor.

17. The system of claim 16, further comprising a heat exchanger positioned prior to an inlet of the separator vessel.

18. The system of claim 17, further comprising a cooling fluid.

19. The system of claim 1, further comprising of a filter vessel prior to the inlet of the treatment contactor.

20. The system of claim 1, further comprising a filter vessel after the initial outlet of the treatment contactor where the treated hydrocarbon fluid undergoes additional conditioning.
